(19) United States
(12) Patent Application Publication
(10) Pub. No.: US 2013/0147928 A1
(43) Pub. Date: Jun. 13, 2013

(54) ELECTRONIC DEVICE AND PAYMENT METHOD THEREOF

(71) Applicants: Seunghyun WOO, Seoul (KR); Hayang JUNG, Seoul (KR)

(72) Inventors: Seunghyun WOO, Seoul (KR); Hayang JUNG, Seoul (KR)

(73) Assignee: LG ELECTRONICS INC., Seoul (KR)

(21) Appl. No.: 13/617,055

(22) Filed: Sep. 14, 2012

(30) Foreign Application Priority Data
Dec. 9, 2011 (KR) 10-2011-0131776

(51) Int. Cl. H04N 13/04; G06T 15/00

(52) U.S. Cl. 348/51; 345/419; 348/E13.075

(57) ABSTRACT

The embodiments of the present invention are directed to electronic devices and methods of controlling the electronic devices. The electronic device provides a user interface to set up a depth range allowable for a stereoscopic video and adjusts the depth of the stereoscopic image based on the depth range set trough the user interface.

### CROSS-REFERENCE TO RELATED APPLICATION

This application claims benefit and priority from Korean Patent Application No. 10-2011-0131776, filed Dec. 9, 2011, the subject matters of which are hereby incorporated by reference.

### BACKGROUND

1. Field

Embodiments relate to an electronic device and a payment method thereof

2. Background

Electronic devices may be classified into mobile and stationary terminals according to mobility. Again, the electronic devices may be classified into handheld and vehicle-mount terminals according to portability.

A recent increase in electronic devices having 3D image display functionality prompts users' desire to enjoy various contents in 3D.

Meanwhile, if the depth in stereovision suddenly increases, it takes a while for a user's eyes to be adapted to the increased depth, thus instantly causing a wrong focus. Furthermore, there is a discrepancy in degree by which every user feels stereovision, so that the degree of 3D effects they consider as the optimal ones may differ from user to user.

However, there are no clear standards for the depth of 2D images, which, from the point of view of 3D image producers, render them to create 3D images with no standards, and to users who use the 3D images are provided no particular ways to allow them to control the 3D effects to be suited for themselves.

Accordingly, it has been considered to improve the structure and/or software of electronic devices to be able to control the depth of 3D images so that users may feel 3D effects to fit them.

### SUMMARY

According to an aspect of the present invention, there is provided an electronic device including a display module having a panel configured to implement stereoscopic vision, wherein the display module is configured to display a stereoscopic image using the panel and a controller configured to provide a user interface to set up a depth range allowable for the stereoscopic image and configured to adjust a depth of the stereoscopic image based on the depth range set through the user interface.

According to an aspect of the present invention, there is provided a method of controlling an electronic device having a panel configured to implement stereoscopic vision, the method including providing a user interface configured to set up a depth range allowable for a stereoscopic image, setting up the depth range through the user interface, and adjusting a depth of the stereoscopic image based on the set depth range.

### BRIEF DESCRIPTION OF THE DRAWINGS

The accompanying drawings, which are included to provide a further understanding of described embodiments of the present invention and are incorporated in and constitute a part of this specification, illustrate embodiments of the present invention and together with the description serve to explain aspects and features of the present invention.

FIG. 1 is a block diagram illustrating a configuration of an electronic device according to an embodiment of the present invention.

FIGS. 2 and 3 are views for describing a method of displaying a stereoscopic image using binocular parallax according to embodiments of the present invention.

FIG. 4 is a view for describing a depth of a stereoscopic image according to stereoscopic vision of the stereoscopic image according to an embodiment of the present invention.

FIG. 5 is a flowchart illustrating a method of controlling the electronic device 100 according to a first embodiment of the present invention.

FIG. 6 illustrates examples of a user interface to set up a depth range for a particular frame.

FIG. 7 shows another example of a user interface to set up a depth range for a particular frame.

FIGS. 8A and 8B illustrate other examples of the progress bar.

FIG. 9 illustrates a method of adjusting the degrees of parallax of objects included in a frame based on a depth range.

FIG. 10 illustrates an example of a user interface to select whether to store the changed depth information.

FIG. 11 is a flowchart illustrating a method of controlling the electronic device 100 according to the second embodiment of the present invention.

FIG. 12 illustrates examples of the user interface to set up the depth range for the stereoscopic video.

FIGS. 13 and 14 illustrate examples of applying the pre-selected depth range to frames selected by a user.

### DETAILED DESCRIPTION

Embodiments of the present invention will now be described more fully with reference to the accompanying drawings, in which certain embodiments of the invention are illustrated. The invention may, however, be embodied in many different forms and should not be construed as being limited to the embodiments set forth herein; rather, these embodiments are described and/or illustrated so that this disclosure will be more thorough and complete, and will more fully convey the aspects of the invention to those skilled in the art.

Hereinafter, an electronic device according to embodiments of the present invention will be described below in more detail with reference to the accompanying drawings. In the following description, the suffixes “module” and “unit” are used in reference to components of the electronic device for convenience of description and do not have meanings or functions different from each other.

The electronic devices described herein may include a cellular phone, a smart phone, a laptop computer, a digital broadcasting terminal, a personal digital assistant (PDA), a portable multimedia player (PMP), and a navigation system.

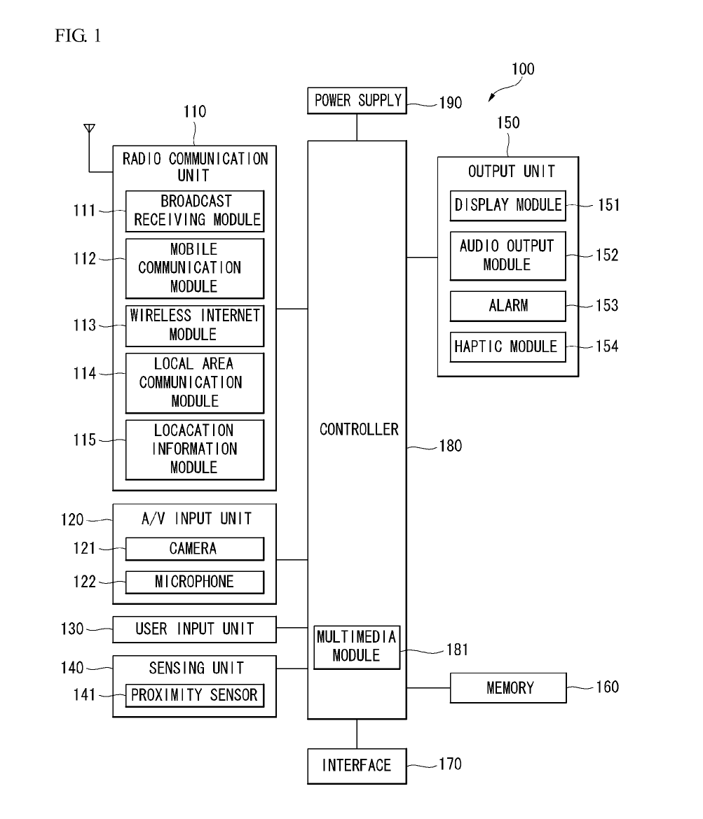

FIG. 1 is a block diagram of an electronic device 100 according to an embodiment of the present invention. It is understood that other embodiments, configurations and arrangements may also be provided. With reference to FIG. 1, the electronic device 100 may include a wireless communication unit 110, an audio/video (A/V) input unit 120, a user input unit 130, a sensing unit 140, an output unit 150, a memory 160, an interface unit 170, a controller 180, and a power supply 190. Not all of the components shown in FIG. 1 are essential, and the number of components included in the electronic device 100 may be varied. The components of the electronic device 100, as illustrated with reference to FIG. 1 will now be described.

The wireless communication unit 110 may include at least one module that enables wireless communication between the electronic device 100 and a wireless communication system or between the electronic device 100 and a network in which the electronic device 100 is located. For example, the wireless communication unit 110 may include a broadcast receiving module 111, a mobile communication module 112, a wireless Internet module 113, a local area (or short-range) communication module 114, and a location information (or position-location) module 115.

The broadcast receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, wireless broadcasting signals, and data broadcasting signals, but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in any of various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcast receiving module 111 may receive broadcasting signals using various broadcasting systems. More particularly, the broadcast receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO™) system, a DVB-H system, and an integrated services digital broadcast-terrestrial (ISDB-T) system. The broadcast receiving module 111 may receive signals from broadcasting systems providing broadcasting signals other than the above-described digital broadcasting systems.

The broadcasting signals and/or broadcasting related information received through the broadcast receiving module 111 may be stored in the memory 160. The mobile communication module 112 may transmit/receive a wireless signal to/from at least one of a base station, an external terminal and a server on a mobile communication network. The wireless signal may include a voice call signal, a video call signal or data in various forms according to the transmission and reception of text/multimedia messages.

The wireless Internet module 113 may correspond to a module for wireless Internet access and may be included in the electronic device 100 or may be externally attached to the electronic device 100. Wireless LAN (WLAN or Wi-Fi), wireless broadband (Wibro™), world interoperability for microwave access (Wimax™), high speed downlink packet access (HSDPA) and other technologies may be used as a wireless Internet technique.

The local area communication module 114 may correspond to a module for local area communication. Further, Bluetooth™, radio frequency identification (RFID), infrared data association (IrDA), ultra wideband (UWB) and/or ZigBee™ may be used as a local area communication technique.

The position-location module 115 may confirm or obtain the position of the electronic device 100. The position-location module 115 may obtain position information by using a global navigation satellite system (GNSS). The GNSS refers to a radio navigation satellite system that revolves around the earth and transmits reference signals to predetermined types of radio navigation receivers such that the radio navigation receivers may determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan among others.

A global positioning system (GPS) module is one example of the position-location module 115. The GPS module 115 may calculate information regarding distances between one point or object and at least three satellites and information regarding a time when the distance information is measured and apply trigonometry to the obtained distance information to obtain three-dimensional position information on the point or object according to latitude, longitude and altitude at a predetermined time. A method of calculating position and time information using three satellites and correcting the calculated position and time information using another satellite may also be used. In addition, the GPS module 115 may continuously calculate the current position in real time and calculate velocity information using the location or position information.

As shown in FIG. 1, the A/V input unit 120 may input an audio signal or a video signal and include a camera 121 and a microphone 122. The camera 121 may process image frames of still images or moving pictures obtained by an image sensor in a video call mode or a photographing mode. The processed image frames may be displayed on a display module 151 which may be a touch screen.

The image frames processed by the camera 121 may be stored in the memory 160 or may be transmitted to an external device through the wireless communication unit 110. The electronic device 100 may also include at least two cameras 121.

The microphone 122 may receive an external audio signal in a call mode, a recording mode or a speech recognition mode and process the received audio signal into electronic audio data. The audio data may then be converted into a form that may be transmitted to a mobile communication base station through the mobile communication module 112 and output in the call mode. The microphone 122 may employ various noise removal algorithms (or noise canceling algorithms) for removing or reducing noise generated when the external audio signal is received.

The user input unit 130 may receive input data required for controlling the electronic device 100 from a user. The user input unit 130 may include a keypad, a dome switch, a touch pad (e.g., constant voltage/capacitance), a jog wheel, and a jog switch.

The sensing unit 140 may sense a current state of the electronic device 100, such as an open/closed state of the electronic device 100, a position of the electronic device 100, whether a user touches the electronic device 100, a direction of the electronic device 100, and acceleration/deceleration of the electronic device 100, and generate a sensing signal required for controlling the electronic device 100. For example, if the electronic device 100 is a slide phone, the sensing unit 140 may sense whether the slide phone is opened or closed. Further, the sensing unit 140 may sense whether the power supply 190 supplies power and/or whether the interface unit 170 is connected to an external device. The sensing unit 140 may also include a proximity sensor 141.

The output unit 150 may generate visual, auditory and/or tactile output and may include the display module 151, an audio output module 152, an alarm unit 153 and a haptic module 154. The display module 151 may display information processed by the electronic device 100. The display module 151 may display a user interface (UI) or a graphic user interface (GUI) related to a voice call when the electronic device 100 is in the call mode. The display module 151 may also display a captured and/or received image and a UI or a GUI when the electronic device 100 is in the video call mode or the photographing mode.

In addition, the display module 151 may include at least a liquid crystal display, a thin film transistor liquid crystal display, an organic light-emitting diode display, a flexible display or a three-dimensional display. Some of these displays may be of a transparent type or a light transmissive type. That is, the display module 151 may include a transparent display.

The transparent display may include a transparent liquid crystal display. The rear of the display module 151 may include a light transmissive type display. Accordingly, a user may be able to see an object located behind the body of the electronic device 100 through the transparent portion of the display unit 151 on the body of the electronic device 100.

The electronic device 100 may also include at least two display modules 151. For example, the electronic device 100 may include a plurality of display modules 151 that are arranged on a single face of the electronic device 100 and spaced apart from each other at a predetermined distance or that are integrated together. The plurality of display modules 151 may also be arranged on different sides of the electronic device 100.

Further, when the display module 151 and a touch-sensing sensor (hereafter referred to as a touch sensor) form a layered structure that is referred to as a touch screen, the display module 151 may be used as an input device in addition to an output device. The touch sensor may be in the form of a touch film, a touch sheet, or a touch pad, for example.

The touch sensor may convert a variation in pressure, applied to a specific portion of the display module 151, or a variation in capacitance, generated at a specific portion of the display module 151, into an electric input signal. The touch sensor may sense pressure, position, and an area (or size) of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display module 151.

The proximity sensor 141 of the sensing unit 140 may be located in an internal region of the electronic device 100, surrounded by the touch screen, or near the touch screen. The proximity sensor 141 may sense the presence of an object approaching a predetermined sensing face or an object located near the proximity sensor using an electromagnetic force or infrared rays without mechanical contact. The proximity sensor 141 may have a lifetime longer than a contact sensor and may thus be more appropriate for use in the electronic device 100.

The proximity sensor 141 may include a transmission type photoelectric sensor, a direct reflection type photoelectric sensor, a mirror reflection type photoelectric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be considered as a proximity sensor 141.

For the convenience of description, an action in which a pointer approaches the touch screen without actually touching the touch screen may be referred to as a proximity touch, and an action in which the pointer is brought into contact with the touch screen may be referred to as a contact touch. The proximity touch point of the pointer on the touch screen may correspond to a point of the touch screen at which the pointer is perpendicular to the touch screen.

The proximity sensor 141 may sense the proximity touch and a proximity touch pattern (e.g., a proximity touch distance, a proximity touch direction, a proximity touch velocity, a proximity touch time, a proximity touch position, a proximity touch moving state). Information corresponding to the sensed proximity touch action and proximity touch pattern may then be displayed on the touch screen.

The audio output module 152 may output audio data received from the wireless communication unit 110 or stored in the memory 160 in a call signal receiving mode, a call mode or a recording mode, a speech recognition mode and a broadcast receiving mode. The audio output module 152 may output audio signals related to functions performed in the electronic device 100, such as a call signal incoming tone and a message incoming tone. The audio output module 152 may include a receiver, a speaker, and/or a buzzer. The audio output module 152 may output sounds through an earphone jack. The user may listen to the sounds by connecting an earphone to the earphone jack.

The alarm unit 153 may output a signal indicating generation (or occurrence) of an event of the electronic device 100. For example, alarms may be generated when a call signal or a message is received and when a key signal or a touch is input. The alarm unit 153 may also output signals different from video signals or audio signals, for example, a signal indicating generation of an event through vibration. The video signals or the audio signals may also be output through the display module 151 or the audio output module 152.

The haptic module 154 may generate various haptic effects that the user may feel. One of the haptic effects is vibration. The intensity and/or pattern of a vibration generated by the haptic module 154 may also be controlled. For example, different vibrations may be combined with each other and output or may be sequentially output.

The haptic module 154 may generate a variety of haptic effects including an effect attributed to an arrangement of pins vertically moving against a contact skin surface, an effect attributed to a jet force or a suctioning force of air through a jet hole or a suction hole, an effect attributed to a rubbing of the skin, an effect attributed to contact with an electrode, an effect of stimulus attributed to an electrostatic force, and an effect attributed to a reproduction of cold and warmth using an element for absorbing or radiating heat in addition to vibrations.

The haptic module 154 may not only transmit haptic effects through direct contact but may also allow the user to feel haptic effects through the user's fingers or arms. The electronic device 100 may also include a plurality of haptic modules 154.

The memory 160 may store a program for operating the controller 180 and temporarily store input/output data such as a phone book, messages, still images, and/or moving pictures. The memory 160 may also store data regarding various patterns of vibrations and sounds that are output from when a touch input is applied to the touch screen.

The memory 160 may include at least a flash memory, a hard disk type memory, a multimedia card micro type memory, a card type memory such as SD or XD memory, a random access memory (RAM), a static RAM (SRAM), a read-only memory (ROM), an electrically erasable programmable ROM (EEPROM), a programmable ROM (PROM) magnetic memory, a magnetic disk, or an optical disk. The electronic device 100 may also operate in association with a web storage performing the storage function of the memory 160 on the Internet.

The interface unit 170 may serve as a path to external devices connected to the electronic device 100. The interface unit 170 may receive data or power from the external devices, transmit the data or power to internal components of the electronic device 100, or transmit data of the electronic device 100 to the external devices. For example, the interface unit 170 may include a wired/wireless headset port, an external charger port, a wired/wireless data port, a memory card port, a port for connecting a device having a user identification module, an audio I/O port, a video I/O port, and/or an earphone port.

The interface unit 170 may also interface with a user identification module that is a chip that stores information for authenticating authority to use the electronic device 100. For example, the user identification module may be a user identity module (UIM), a subscriber identity module (SIM) and a universal subscriber identify module (USIM). An identification device including the user identification module may also be manufactured in the form of a smart card. Accordingly, the identification device may be connected to the electronic device 100 through a port of the interface unit 170.

The interface unit 170 may also be a path through which power from an external cradle is provided to the electronic device 100 when the electronic device 100 is connected to the external cradle or a path through which various command signals input by the user through the cradle are provided to the electronic device 100. The various command signals or power input from the cradle may be used as signals for checking whether the electronic device 100 is correctly settled (or loaded) in the cradle.

The controller 180 may control overall operations of the electronic device 100. For example, the controller 180 may control and process voice communication, data communication and/or a video call. The controller 180 may also include a multimedia module 181 for playing a multimedia file. The multimedia module 181 may be included in the controller 180 as shown in FIG. 1 or may be separated from the controller 180.

The controller 180 may perform a pattern recognition process of recognizing handwriting input or picture-drawing input applied to the touch screen as characters or images. The power supply 190 may receive external power and internal power and provide power required for operating the components of the electronic device 100 under the control of the controller 180.

According to a hardware implementation, embodiments of the present invention may be implemented using at least application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented using the controller 180.

According to a software implementation, embodiments including procedures or functions may be implemented using a separate software module executing at least one function or operation. Software code may be implemented according to a software application written in an appropriate software language. The software codes may be stored in the memory 160 and executed by the controller 180.

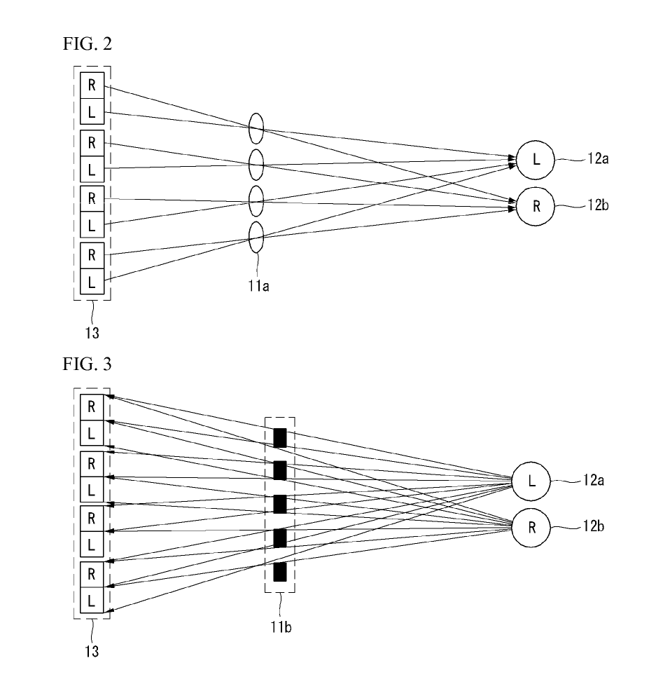

FIGS. 2 and 3 are views for describing a method of displaying a stereoscopic image using binocular parallax according to embodiments of the present invention. FIG. 2 illustrates a method of using a lenticular lens array, and FIG. 3 illustrates a method of using a parallax barrier.

Binocular parallax refers to difference in the apparent position of an object viewed along two different lines of sight. An image viewed by his right eye and an image viewed by his left eye may be synthesized in his brain, and the resultant synthesized image makes him feel a 3D effect.

Hereinafter, the phenomenon which allows a human being to feel a 3D effect based on binocular parallax is referred to as “stereoscopic vision” and an image that causes the stereoscopic vision is referred to as a “stereoscopic image”. Further, a video that causes stereoscopic vision is referred to as a “stereoscopic video”.

Further, an object that is included in a stereoscopic image and causes stereoscopic vision is referred to as a “stereoscopic object”. A content produced to generate stereoscopic vision is referred to as a “stereoscopic content”. Examples of the stereoscopic content may include stereoscopic images and stereoscopic objects.

Methods of displaying stereoscopic images using binocular parallax may be classified into glasses types and non-glasses types.

The glasses types include using colorful glasses having wavelength selectivity, polarized glasses type using light-shield effects based on differences in polarization, and time-divisional types that alternately offer left and right images during the time that an eye maintains its afterimage. Besides, filters having different transmittances from each other may be positioned before left and right eyes to obtain stereoscopic effects for leftward and rightward moves according to differences in time of a vision system, which come from discrepancies in transmittances.

The non-glasses types may include parallax barrier types, lenticular lens types, and microlens array types.

Referring to FIG. 2, to display a stereoscopic image, the display module 151 includes a lenticular lens array 11 a. The lenticular lens array 11a is positioned between a display plane 13 and a user's left and right eyes 12a and 12b. Pixels L corresponding to the left eye 12a and pixels R corresponding to the right eye 12b are alternately arrayed in the display plane 13 along a horizontal direction. The lenticular lens array 11 a provides optical selective directivity to the pixels L and the pixels R. Accordingly, passing through the lenticular lens array 11a, an image is separately observed by the left and right eyes 12a and 12a, and the user's brain synthesizes the images viewed by the left and right eyes 12a and 12b, thereby observing a stereoscopic image.

Referring to FIG. 3, to display a stereoscopic image, the display module 151 includes a vertical lattice-shaped parallax barrier 11b. The vertical lattice-shaped parallax barrier 11b is positioned between a display plane 13 and a user's left and right eyes 12a and 12b. Pixels L corresponding to the left eye 12a and pixels R corresponding to the right eye 12b are alternately arrayed in the display plane 13 along a horizontal direction. An image is separately observed by the left and right eyes 12a and 12b through vertical lattice-shaped apertures of the parallax barrier 11b. The user's brain synthesizes the images viewed by the left and right eyes 12a and 12b, thereby observing a stereoscopic image. The parallax barrier 11b is turned on only when a stereoscopic image is displayed to separate a coming viewed image, and is turned off when a plane image is displayed to pass a coming viewed image therethrough without separating it.

The above-described stereoscopic image displaying methods are merely provided as examples, and the embodiments of the invention are not limited thereto. Various methods of using binocular parallax other than those described above may be adopted to display stereoscopic images.

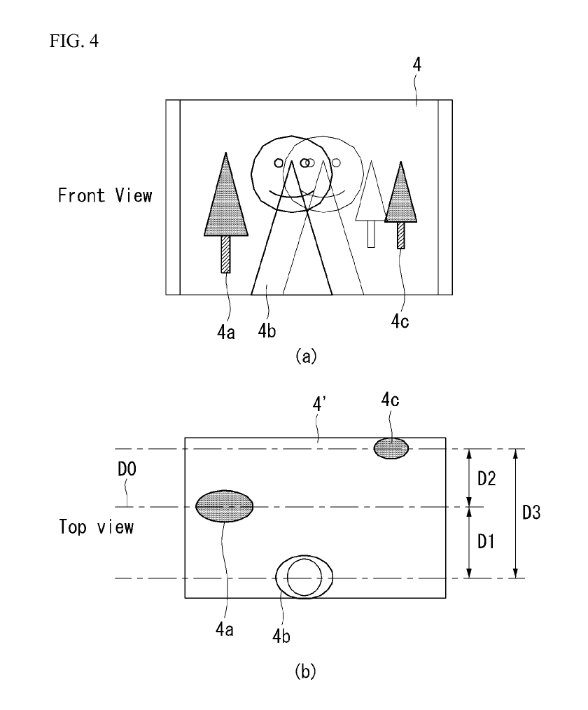

FIG. 4 is a view for describing a depth of a stereoscopic image according to stereoscopic vision of the stereoscopic image according to an embodiment of the present invention.

(a) of FIG. 4 illustrates an example where a stereoscopic image 4 displayed through the display module 151 is viewed from front, and (b) of FIG. 4 illustrates an example where a virtual stereoscopic space 4′ generated due to stereoscopic vision by the stereoscopic image 4 is viewed from top.

Referring to (a) of FIG. 4, objects 4a, 4b, and 4c included in the stereoscopic image 4 have different degrees of parallax. Here, the parallax occurs due to a display point on the left image of an object and a display point on the right image of the object. Specifically, upon synthesizing the stereoscopic image 4, a point where the object is displayed on the left image happens to differ from a point where the object is displayed on the right object, which causes the parallax.

Such parallax of the objects gives the objects stereoscopic effects, i.e., depths according to stereoscopic vision, which vary depending on the degrees of the parallax. For example, as the depth of an object comes close to the display plane, the degree of parallax of the object reduces, and as the depth gets away from the display plane, the degree of parallax increases.

Taking as an example what is illustrated in (b) of FIG. 4, the first object 4a, which has little parallax, has a depth DO corresponding to the display plane, and the second and third objects 4b and 4c, which have larger depths than that of the first object 4a, may respectively have a depth D1 to allow the object 4b to appear to be protruded from the display plane and a depth D2 to allow the object 4c to appear to be depressed from the display plane.

For convenience of description, when providing a 3D effect so that an object appears to be depressed from the display plane, the parallax is hereinafter referred to as “positive parallax”, and when providing a 3D effect so that the object appears to be protruded from the display plane, the parallax is hereinafter referred to as “negative parallax”.

According to (b) of FIG. 4, the second object 4b has negative parallax, so that it appears to be protruded from the display plane DO in the virtual stereoscopic space 4, and the third object 4c has positive parallax, so that it appears to be depressed from the display plane in the virtual stereoscopic space 4′.

As used herein, it is assumed that a stereoscopic image occurs in a depth range that is determined based on the maximum degree of positive parallax and the maximum degree of negative parallax that may be generated by objects included in the stereoscopic image.

According to (b) of FIG. 4, the stereoscopic image 4 has a depth range from the depth D1 of the object 4b which exhibits the maximum degree of negative parallax and to the depth D2 of the object 4c which exhibits the maximum degree of positive parallax.

The embodiments disclosed herein may be implemented by the electronic device 100 described in connection with FIG. 1.

Each and every component of the electronic device 100 are now described in greater detail according to embodiments of the present invention.

The display module 151 may include a panel to generate stereoscopic vision. The panel may have a structure to implement stereoscopic vision in the above-described lenticular lens type or parallax barrier type.

The display module 151 is assumed to be a touch screen 151. As described above, the touch screen 151 may perform information display/input functions, but not limited thereto.

As used herein, a touch gesture refers to a gesture implemented by touching the touch screen 151 or by placing a touching object, such as a finger, adjacent to the touch screen 151.

Examples of the touch gesture may include, according to the action, tapping, dragging, flicking, pressing, multi touch, pinch in, and pinch out.

“Tapping” refers to an action of lightly pressing the touch screen 151 with, e.g., a finger, and then taking it back. Tapping is a touch gesture similar to mouse clicking in case of a general computer.

“Dragging” refers to an action of moving, e.g., a finger, to a particular location with the touch screen 151 touched, and then taking it back. While dragged, an object may remain displayed along the direction of dragging.

“Flicking” refers to an action of, after the touch screen 151 is touched, moving, e.g., a finger, along a certain direction (e.g., upper, lower, left, right, or diagonal direction) and then taking it back. When receiving a touch input by flicking, the electronic device 100 performs a specific operation, e.g., page turning of an e-book, based on the direction and speed of flicking

“Pressing” refers to an action of maintaining a touch on the touch screen 151 during a predetermined time.

“Multi touch” refers to an action of touching multiple points on the touch screen 151.

“Pinch in” refers to an action of performing dragging so that multiple points multi-touched on the touch screen 151 come closer to each other. Specifically, “pinch in” allows multi-touched multiple points to be dragged in the direction of coming closer to each other, starting from at least one of the multi-touched multiple points.

“Pinch out” refers to an action of performing dragging so that multiple points multi-touched on the touch screen 151 go apart from each other. Specifically, “pinch out” allows multi-touched multiple points to be dragged in the direction of being apart from each other, starting from at least one of the multi-touched multiple points.

The controller 180 provides a user interface (UI) to set up a depth range allowable for a stereoscopic image.

Further, the controller 180 sets up a depth range for a stereoscopic image based on a control input received through the user interface and controls the depth of at least one of objects included in the stereoscopic image based on the set depth range.

According to an embodiment, the stereoscopic image may be a still image, such as a figure or picture, or a particular frame constituting a moving picture, such as a video. For ease of description, a frame constituting a video is exemplified as the stereoscopic image. However, the embodiments of the present invention are not limited thereto.

A method of controlling an electronic device and an operation of the electronic device 100 to implement the same according to a first embodiment of the present invention are now described in greater detail with reference to the drawings.

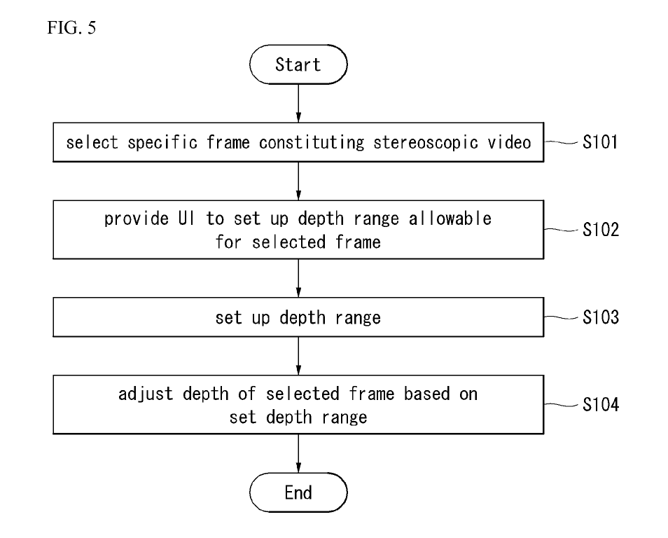

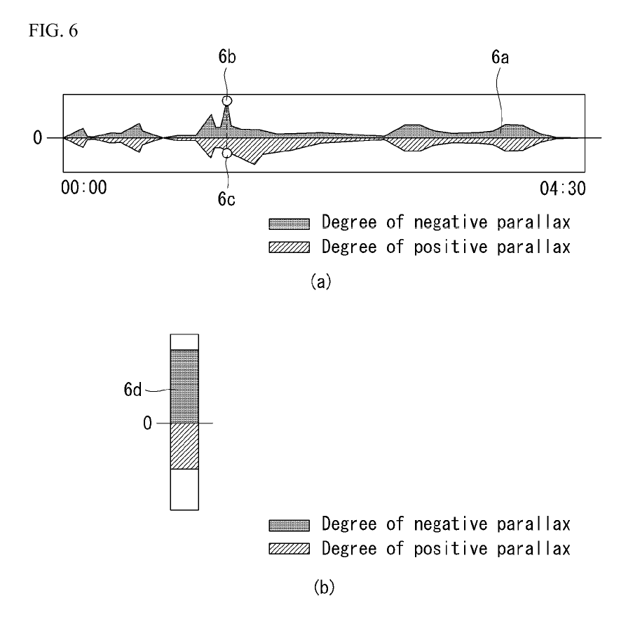

FIG. 5 is a flowchart illustrating a method of controlling the electronic device 100 according to a first embodiment of the present invention. FIGS. 6 to 10 are views for describing the control method according to the first embodiment of the present invention.

Referring to FIG. 5, the controller 180 selects a particular frame included in a stereoscopic image based on a user's control input (S101).

Further, the controller 180 provides a user interface (UI) to set up a depth range allowable for the selected frame (S102).

Then, the controller 180 sets up a depth range allowable for the specific frame based on a control input received through the user interface (S103).

Further, the controller 180 adjusts the depth of the specific frame based on the set depth range (S104). For example, the controller 180 controls the depth of at least one of objects included in the frame so that the depths of the objects are all included in the depth range. The depth of each object may be adjusted by controlling the parallax of the object as described above.

In step S101, when only the specific frame is selected to set the depth range, the controller 180 may select the frame by various methods.

For example, the controller 180 may choose the frame based on an order of playing the stereoscopic video. The controller 180 may sequentially play frames according to the playing order, and when a user's request is entered while in play, may select the playing frame as the target for setting up the depth range.

Further, for example, the controller 180 may select a frame through a progress bar that indicates a current playing position of a video. When the progress bar indicating the current position of the stereoscopic video is changed by a user, the controller 180 may make selection of the frame based on the point indicated by the changed progress bar.

Still further, for example, the controller 180 may select a frame by manipulating a button corresponding to a shifting function between frames. When a shift to a specific frame occurs by manipulation of the button, the controller 180 may select the shifted frame as the depth range setup target.

Yet still further, for example, the controller 180 may also choose a frame using a key frame. The controller 180 may display a list of key frames, and when any one is selected among the key frames, may select the selected frame as the depth range setup target.

In step S102, upon providing the user interface, the controller 180 may also display the current depth state of the selected frame so that a user may refer to it to set up the depth range. Accordingly, when determining that there is a need of restricting the depth by watching the current depth state of the selected frame, a user may adjust the allowable depth range.

FIG. 6 illustrates examples of a user interface to set up a depth range for a particular frame.

Referring to (a) of FIG. 6, the controller 180 displays a graph 6a indicating changes with time in the depth of a stereoscopic video based on the depth, depending on stereoscopic vision, of each of frames constituting the stereoscopic video

Here, the stereoscopic vision-dependent depth of each frame is obtained based on the depths of objects included in the frame. The depth of each object corresponds to the parallax of the object as described above. For example, the graph shown in (a) of FIG. 6 may be represented based on the parallax of the objects included in each frame.

Referring to (a) of FIG. 6, the graph 6a represents a negative parallax region over the display plane and a positive parallax region under the display plane. The controller 180 represents the stereoscopic vision-dependent depth that is generated by each frame using the maximum degree of positive parallax or the maximum degree of negative parallax exhibited by the objects included in each frame.

As shown in (a) of FIG. 6, when the changes with time in depth of the stereoscopic video are represented in a single graph, the controller 180 may select a specific frame desired to set up a depth range.

Further, the controller 180 displays items 6b and 6c that may set up depth ranges for the selected frame. The items 6b and 6c are positioned to correspond to the maximum degree of positive parallax and the maximum degree of negative parallax of the selected frame. A user may drag the items 6b and 6c to change the maximum degree of positive parallax and the maximum degree of negative parallax of the graph 6a, thereby setting up a desired depth range.

Referring to (b) of FIG. 6, when a specific frame is selected among frames constituting the stereoscopic video, the controller 180 displays a bar graph 6d that represents the depth of the selected frame.

Referring to (b) of FIG. 6, the graph 6d represents a negative parallax region over the display plane and a positive parallax region under the display plane. The controller 180 represents the depth of the selected frame using the depth of the object showing the maximum degree of positive parallax of the maximum degree of negative parallax among the objects of the selected frame.

In the case that the depth of the selected frame is displayed as shown in (b) of FIG. 6, a user may set up his desired depth range by dragging the graph 6d, thereby increasing or decreasing the graph 6d.

The embodiments of the present invention are not limited to the examples of the user interface to set up the depth range for a specific frame as shown in FIG. 6. According to an embodiment, the controller 180 may display the depth state of the selected frame in other forms than the graphs and may set up the depth range by appropriate methods according to the displaying methods.

For example, the controller 180 may represent the depth state of the selected frame as a number, and if the number is changed by a user, may set up the depth range based on the changed depth.

Turning back to FIG. 5, upon provision of the user interface in step S102, the controller 180 may also display a preview image of the selected frame so that a user may refer to it to set up the depth range. Accordingly, the user may intuitively notice a change in the stereoscopic video depending on the changed depth state in addition to the current depth state of the selected frame.

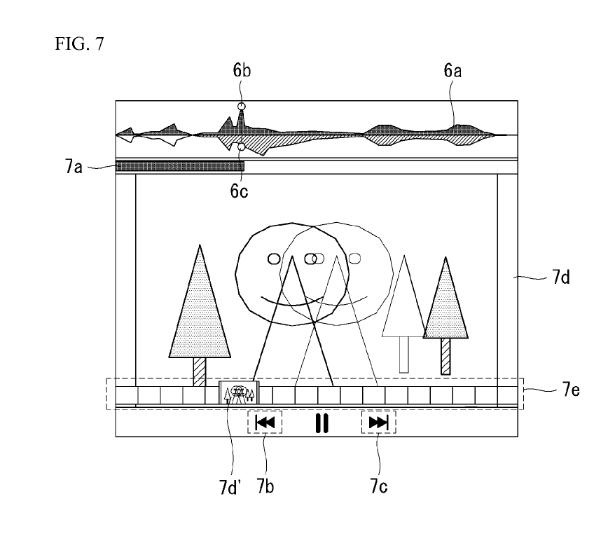

FIG. 7 shows another example of a user interface to set up a depth range for a particular frame.

Referring to FIG. 7, the controller 180 displays, with a graph 6a, changes with time in depths of frames constituting a stereoscopic video.

Further, the controller 180 ma provide a progress bar 7a and buttons 7b and 7c to allow a user to select any one of the frames included in the stereoscopic video.

The progress bar 7a is an indicator that indicates a current playing position of the stereoscopic video. A user may select his desired frame by dragging the progress bar 7a.

The buttons 7c and 7d are also referred to playing position shifting buttons that allow the playing position to be shifted forward or rearward. A user may select a desired frame by manipulating the buttons 7c and 7d.

The controller 180 may provide a list 7e of key frames selected among the frames constituting the stereoscopic video. The key frame list 7e may include predetermined key frames or may be configured by arranging, according to the playing order, frames satisfying a predetermined condition among the frames constituting the stereoscopic video. The controller 180 may display the key frame list 7e by arranging, based on the playing order of each frame, thumbnail images of the frames selected as the key frames on a portion of the screen. A user may have an intuition on the flow of the stereoscopic video over time through the key frame list 7e and may select any one of the frames in the key frame list 7e to thereby make shift to the frame.

As described above, when a specific frame is selected by using the progress bar 7a, shift buttons 7b and 7c, and the key frame list 7e, the controller 180 displays on the graph 6a items 6b and 6c to set up an allowable depth range for the selected frame. Further, the controller 180 may display a preview image 7d of the selected frame to allow a user to intuitively notice the depth state of the selected frame.

FIG. 7 illustrates an example of the progress bar, but the embodiments of the present invention are not limited thereto. According to an embodiment, the progress bar may overlap the region where the depth range is displayed.

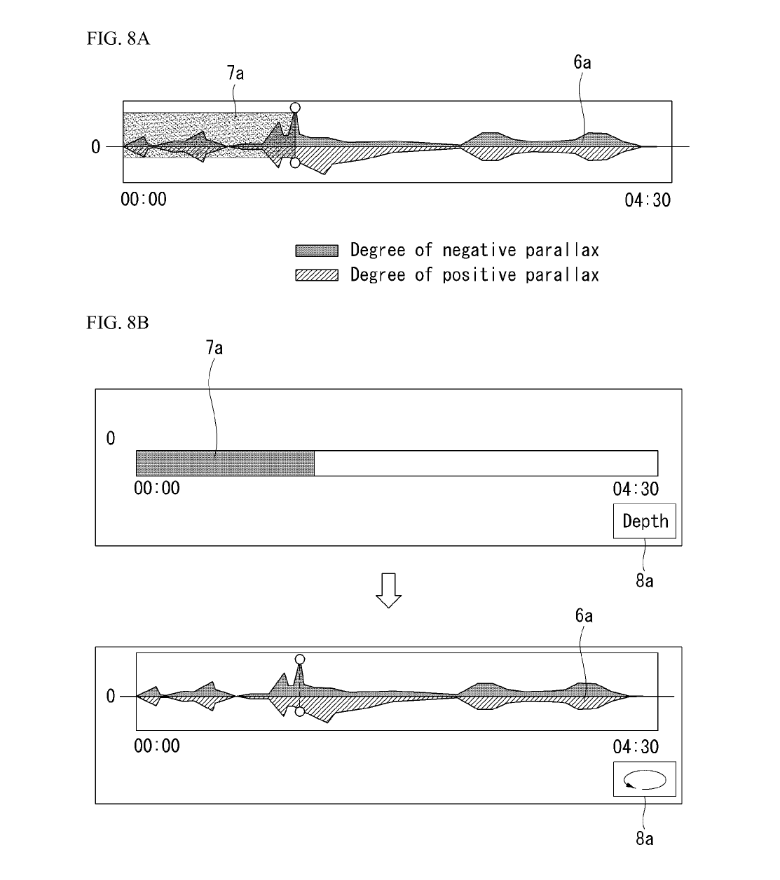

FIGS. 8A and 8B illustrate other examples of the progress bar.

Referring to FIG. 8A, the controller 180 may display a graph 6a representing changes overtime in depths of the frames included in a stereoscopic video and a progress bar 7a in such a manner that the graph 6a overlaps the progress bar 7a.

Referring to FIG. 8B, when a predetermined button 8a is touched while the progress bar 7a is displayed to indicate a current playing position of the stereoscopic video, the controller 180 may display the graph 6a to indicate the time-dependent changes in depths of the frames included in the stereoscopic video instead of the progress bar 7a. That is, the progress bar 7a that indicates the current playing position of the stereoscopic video and the graph 6a that indicates the time-dependent changes in depths of the frames included in the stereoscopic video may be displayed toggling each other.

Referring back to FIG. 5, when the depth range allowable for the frame is set in step S104, the controller 180 detects objects that get out of the set depth range and varies the degrees of parallax of the objects so that the depths of the detected objects are included in the allowable depth range.

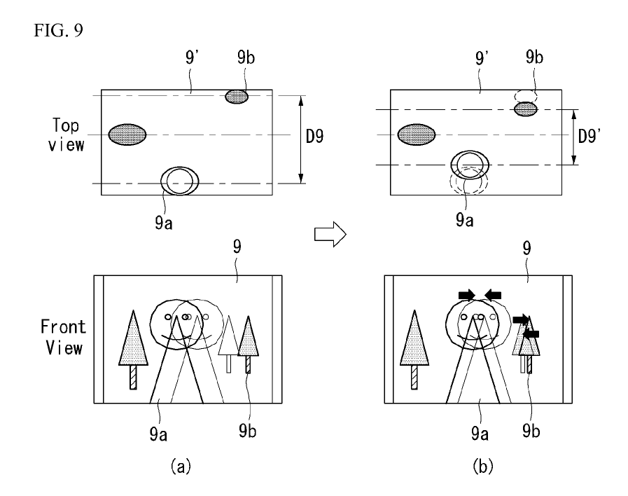

FIG. 9 illustrates a method of adjusting the degrees of parallax of objects included in a frame based on a depth range.

(a) of FIG. 9 shows a preview image 9 of the frame and the positions of the objects in a virtual stereoscopic space 9′ before the depth range is set, and (b) of FIG. 9 shows the preview image 9 and the positions of the objects in the virtual stereoscopic space 9′ after the depth range is set.

Referring to (a) of FIG. 9, the frame has a first depth range D9 by the objects included in the frame 9. That is, the objects are positioned within the first depth range D9 in the virtual stereoscopic space 9′ generated by the frame.

Thereafter, when the depth range allowable for the frame 9 is set by a user as a second depth range D9′, the controller 180 detects objects 9a and 9b having depths that get out of the second depth range D9′ in the frame 9.

Further, as shown in (b) of FIG. 9, the controller 180 shifts the depths of the objects 9a and 9b within the second depth range D9′ by adjusting the parallax of the objects 9a and 9b departing from the second depth range D9′. Here, the parallax of each object may be adjusted by shifting leftward/rightward the position of the object in the left image and right image.

Returning to FIG. 5, when the depths of the objects included in the frame are adjusted to be within the allowable depth range in step S104, the controller 180 may display a preview image of the frame changed based on the adjusted depth of each object. Thus, a user may set the depth range of the frame while identifying the change in the depth in real time.

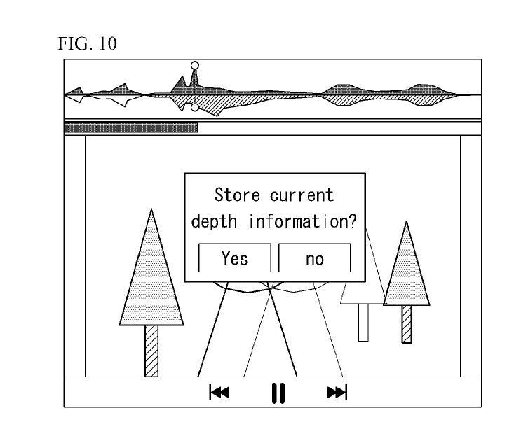

When in step S104 a shift to another frame is made or the stereoscopic video is terminated by a user with the depth of the frame changed, the controller 180 may provide a user interface 10a to select whether to store the changed depth as shown in FIG. 10. Further, the controller 180 selects whether to store the changed depth of the frame based on a control input entered therethrough.

A method of controlling an electronic device and an operation of the electronic device 100 to implement the same according to a second embodiment of the present invention are now described in greater detail with reference to the drawings.

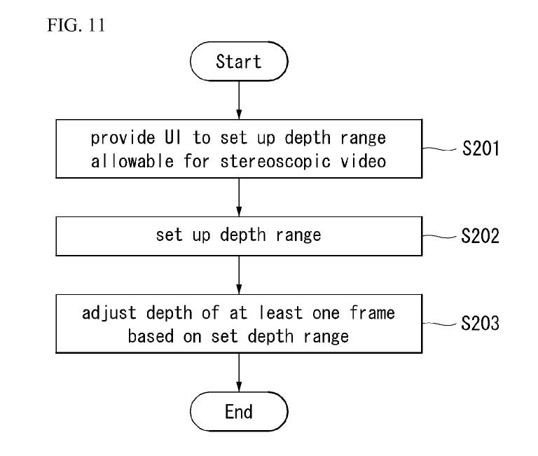

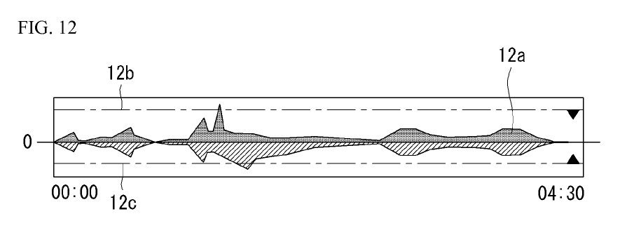

FIG. 11 is a flowchart illustrating a method of controlling the electronic device 100 according to the second embodiment of the present invention. FIGS. 12 to 14 are views for describing the control method according to the second embodiment of the present invention.

Referring to FIG. 11, the controller 180 provides a user interface to set up a depth range allowable for a stereoscopic video based on a user's control input (S201).

Thereafter, the controller 180 sets up the depth range for the stereoscopic video based on the user's control input received through the user interface (S202).

Further, the controller 180 adjusts the depth of at least one frame included in the stereoscopic video based on the set depth range (S203). For example, the controller 180 detects frames departing from the depth range and adjusts the depths of the detected frames to be included in the set depth range.

In step S201, when providing the user interface, the controller 180 may also display the current depth state of the stereoscopic video so that a user may refer to it to set up the depth range. Accordingly, when determining that the depth needs to be restricted by watching the current depth state of the stereoscopic video, the user may adjust the allowable depth range.

FIG. 12 illustrates examples of the user interface to set up the depth range for the stereoscopic video.

Referring to FIG. 12, the controller 180 displays a graph 12a that indicates changes with time in depth of the stereoscopic video based on the depth, depending on stereoscopic vision, of each of the frames constituting the stereoscopic video.

The stereoscopic vision-dependent depth of each frame is obtained by using the depths of the objects included in the frame, and the depth of each object corresponds to the parallax of the left and right images of the object. Accordingly, the graph 12a may be divided into a negative parallax region over the display plane (depth 0) and a positive parallax region under the display plane.

Further, referring to FIG. 12, the controller 180 displays a reference line 12b to indicate the maximum degree of negative parallax allowable for the stereoscopic video and a reference line 12c to indicate the maximum degree of positive parallax allowable for the stereoscopic video. Thus, a user may set up a depth range allowable for all the frames constituting the stereoscopic video by shifting the reference lines 12b and 12c upward/downward.

FIG. 12 illustrates an example of a user interface to set up a depth range allowable for the stereoscopic video, and the embodiments of the present invention are not limited thereto. According to embodiments, various types of user interfaces may be implemented to set up the depth range allowable for the stereoscopic video.

For example, the controller 180 may represent the allowable depth range for the stereoscopic video as a number and may set up the depth range based on a user's input to increase/decrease the depth range.

Referring back to FIG. 11, when the depth range is set in step S203, the controller 180 may automatically adjust the depths of the frames included in the stereoscopic video based on the set depth range.

In such case, when the depth range is set, the controller 180 detects at least one frame that gets out of the set depth range and simultaneously adjusts the depths of the detected frames to be included in the set depth range. An adjusting method may be the same or substantially the same as the depth adjusting method described above in connection with FIG. 9, and thus, the detailed description will be omitted.

When the depth range is set in step S203, the controller 180 may adjust the depth of a fame selected by a user based on the set depth range.

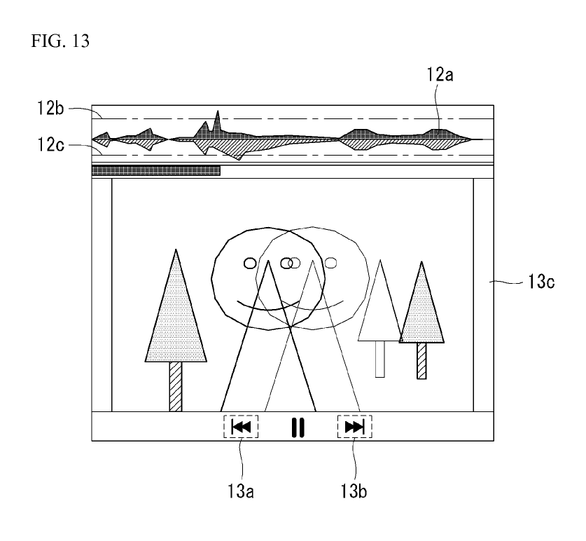

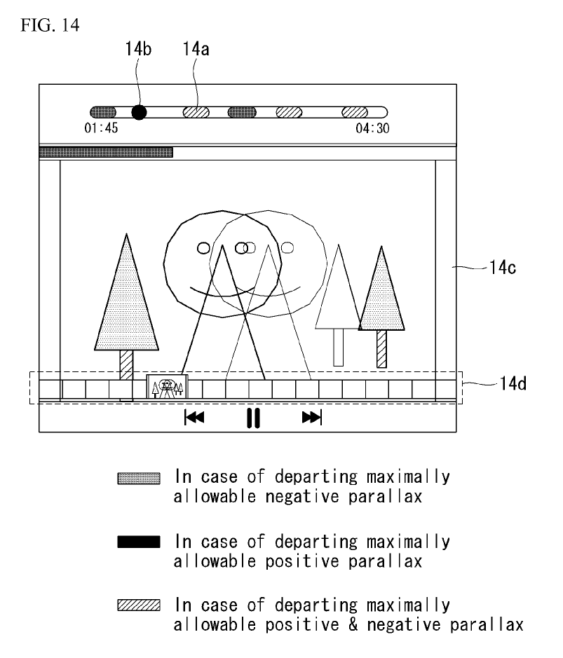

FIGS. 13 and 14 illustrate examples of applying the pre-selected depth range to frames selected by a user.

Referring to FIG. 13, the controller 180 displays changes with time in depths of frames constituting a stereoscopic video using a graph 12a.

Further, the controller 180 may provide buttons 13a and 13b that correspond to functions to make shift to frames departing from the set depth range. Accordingly, a user may make shift to the frames departing from the preset depth range by manipulating the shift buttons 13a and 13b.

Shifted to a particular frame departing from the preset depth range by the user, the controller 180 automatically or selectively adjusts the depth of the frame to be included in the preset depth range.

For example, when a shift is made to the particular frame departing from the preset depth range, the controller 180 may automatically change the depth of the frame to be included in the preset depth range.

Further, for example, when there is a shift to a certain frame departing from the preset depth range, the controller 180 may vary the depth of the frame so that it belongs to the preset depth range based on a user's selective input.

As another example, when shifted to a specific frame departing from the preset depth range, the controller 180 may vary the depth of the frame based on a user's control input. In such case, rather than unconditionally changing the depth of the frame to be included in the present depth range, the controller 180 may provide the preset depth range as a guide to allow the user to adjust the depth range. The user's adjustment of the frame depth may be done in the same way as the depth adjusting method described in the first embodiment.

Referring to FIG. 13, upon shift to a particular frame, the controller 180 may display a preview image 13c of the frame on the screen so that a user may intuitively notice the change in the frame before or after the depth changes.

Referring to FIG. 14, the controller 180 detects frames that get out of the preset depth range among frames constituting the stereoscopic video. Further, the controller 180 displays indicators 14a to indicate the positions of the detected frames in the stereoscopic video.

The indicators 14a to indicate the frames departing from the preset depth range may be configured to indicate how the frames have been off the predetermined depth range.

Referring to FIG. 14, the controller 180 may assign different colors to the indicators 14a depending on whether the frames have departed from the maximum degree of positive or negative parallax allowable by the preset depth range.

In addition, the controller 180 displays an indicator 14b on the screen to indicate the position of the frame being currently played.

A user may make shift to the frame departing from the preset depth range by shifting the indicator 14b indicating the position o the currently playing frame or by touching the indicator 14a indicating the position of the frame departing from the preset depth range.

Further, the controller 180 displays on a portion of the screen a list 14d of thumbnail image respectively corresponding to the frames departing from the preset depth range.

A user may select any one of the frames in the list 14d to thereby make direct shift to the frame.

Upon shift to the particular frame departing from the preset depth range by the user, the controller 180 automatically or selectively adjusts the depth of the frame to be included in the preset depth range as described in connection with FIG. 13.

Further, upon shift to the specific frame, the controller 180 may display a preview image 14c of the frame on the screen so that a user may have an institution on a change in the frame before or after the depth changes.

According to the embodiments, the electronic device 100 allows a user to adjust the depth of a stereoscopic image to fit himself while identifying the depth of the stereoscopic image. Accordingly, the user may adjust the depth of the stereoscopic image to be most appropriate for himself

The disclosed payment method for the electronic device may be written as computer programs and may be implemented in digital microprocessors that execute the programs using a computer readable recording medium. The payment method for the electronic device may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that may store data and may be read by a computer system. Examples of the computer readable recording medium may include read-only memory (ROM), random-access memory (RAM), CD-ROMs, DVD±ROM, DVD-RAM, magnetic tapes, floppy disks, and optical data storage devices. The computer readable recording medium may also be distributed over network coupled computer systems such that the computer readable code is stored and executed in a distributed manner.

The foregoing embodiments and features are merely exemplary in nature and are not to be construed as limiting the present invention. The disclosed embodiments and features may be readily applied to other types of apparatuses. The description of the foregoing embodiments is intended to be illustrative, and not to limit the scope of the claims. Many alternatives, modifications, and variations will be apparent to those skilled in the art.

What is claimed is:

1. An electronic device comprising:
a display module equipped with a panel for generating stereoscopic vision and configured to display a stereoscopic image via the panel; and
a controller configured to:
provide a user interface for setting an allowable depth range for the displayed stereoscopic image, and
adjust a depth of the displayed stereoscopic image based on the set allowable depth range.

2. The electronic device of claim 1, wherein the controller is further configured to:
detect at least one object in the displayed stereoscopic image, wherein the detected at least one object is outside the set allowable depth range; and
adjust the depth of the detected at least one object such that the adjusted depth is inside the set allowable depth range.

3. The electronic device of claim 2, wherein the controller is further configured to:
set a parallax of the detected at least one object such that the depth of the detected at least one object is inside the set allowable depth range.

4. The electronic device of claim 1, wherein the controller is further configured to:
control the display module to display a preview image of the displayed stereoscopic image via the panel;
detect that the depth of the displayed stereoscopic image has changed; and
control the display module to display the preview image with the changed depth in response to the detection.

5. The electronic device of claim 1, wherein the controller is further configured to:
control the display module to display the depth of the displayed stereoscopic image via the user interface.

6. The electronic device of claim 1, wherein:
the displayed stereoscopic image includes at least one frame included in a stereoscopic video; and
the controller is further configured to adjust a depth of the at least one frame based on the set allowable depth range.

7. The electronic device of claim 6, wherein the controller is further configured to:
detect one or more frames of the displayed stereoscopic video, wherein the detected one or more frames are outside the set allowable depth range; and
adjust the depth of the detected one or more frames such that the adjusted one or more frames are inside the set allowable depth range.

8. The electronic device of claim 6, wherein the user interface comprises a graph displaying a change in a depth of the stereoscopic video during a period of time and an item representing the set allowable depth range.

9. The electronic device of claim 8, wherein the controller is further configured to:
move the item; and
set the allowable depth range in response to the moved item.

10. A method for controlling an electronic device having a panel configured to generate stereoscopic vision, the method comprising:
providing a user interface configured to set an allowable depth range for a displayed stereoscopic image;
setting the allowable depth range via the user interface; and
adjusting a depth of the displayed stereoscopic image based on the set allowable depth range.

11. The method of claim 10, further comprising:
detecting at least one object in the displayed stereoscopic image, wherein the detected at least one object is outside the set allowable depth range; and
adjusting the depth of the detected at least one object such that the adjusted depth is inside the set allowable depth range.

12. The method of claim 11, further comprising:
setting a parallax of the detected at least one object such that the depth of the detected at least one object is inside the set allowable depth range.

13. The method of claim 10, further comprising:
displaying a preview image of the displayed stereoscopic image via the panel;
detecting that the depth of the displayed stereoscopic image has changed; and
displaying the preview image with the changed depth in response to the detection.

14. The method of claim 10, further comprising:
displaying the depth of the displayed stereoscopic image via the user interface.

15. The method of claim 1, further comprising:
adjusting a depth of at least one frame included in a stereoscopic video based on the set allowable depth range, wherein the displayed stereoscopic image includes the at least one frame included in the stereoscopic video.

16. The method of claim 15, further comprising:
detecting one or more frames of the stereoscopic video that are outside the set allowable depth range; and
adjusting the depth of the detected one or more frames such that the adjusted one or more frames are inside the set allowable depth range.

17. The method of claim 15, wherein the user interface comprises a graph displaying a change in a depth of the stereoscopic video during a period of time and displaying an item representing the set allowable depth range.

18. The electronic device of claim 17, further comprising:
moving the item; and
setting the allowable depth range in response to the moved item.

19. The method of claim 15, wherein the change in depth of the stereoscopic video is displayed for a specific frame range selected by a user via the user interface.

20. The method of claim 15, wherein the allowable depth range includes a maximum degree of positive parallax and a maximum degree of negative parallax.
